(19) United States
(12) Patent Application Publication
(10) Pub. No.: US 2025/0390078 A1
(43) Pub. Date: Dec. 25, 2025

(54) CONNECTION CIRCUIT FOR A FIELD DEVICE, AND FIELD DEVICE

(71) Applicant: Endress+Hauser Flowtec AG, Reinach (CH)

(72) Inventor: Marc Fiedler, Reinach (CH)

(21) Appl. No.: 18/993,859

(22) PCT Filed: Jun. 6, 2023
(86) PCT No.: PCT/EP2023/065062

§ 371 Date: Jan. 13, 2025

(30) Foreign Application Priority Data
Jul. 29, 2022 (DE) 10 2022 119 145.1

(51) Int. Cl. G05B 19/042

(52) U.S. Cl. CPC G05B 19/0428; G05B 2219/25428

(57) ABSTRACT

A connection circuit for a field device comprises two connections forming a two-wire interface, a microcontroller for operating the field device, a voltage converter connected upstream of the microcontroller and configured to operate the microcontroller with an operating voltage, a supply capacitor connected upstream of the voltage converter and configured to absorb electrical energy when the connection circuit is started and to use it to supply the voltage converter, a first current limiting element connected upstream of the supply capacitor and designed to limit an input current below a permissible limit current when starting the connection circuit, a first bridging element connected in parallel with the first current limiting element and configured to bridge the first current limiting element if a first criterion is satisfied, and a test element configured to check whether the first criterion is satisfied.

The invention relates to a connection circuit for a field device and to a field device having the connection circuit according to the invention.

In automation, particularly in process automation, field devices serving to capture and/or modify process variables are frequently used. For detecting process variables, sensors that are integrated, for example, into fill-level measuring devices, flow meters, pressure and temperature measuring devices, pH-redox potential meters, conductivity meters, etc., are used to detect the respective process variables, such as fill-level, flow, pressure, temperature, pH level, or conductivity. Actuators, such as, for example, valves or pumps, are used to influence process variables. The flow rate of a fluid in a pipeline section or a fill-level in a container can thus be altered by means of actuators. In principle, all devices which are process-oriented and which supply or process process-relevant information are referred to as field devices. In connection with the invention, “field devices” therefore also refer to remote I/Os, radio adapters, or, in general, electronic measuring components that are disposed at the field level.

A field device is in particular selected from a group consisting of flow meters, fill level measuring devices, pressure measuring devices, temperature measuring devices, limit level measuring devices and/or analytical measuring devices.

Flow meters are, in particular, Coriolis, ultrasound, vortex, thermal and/or magnetically-inductive flow meters.

Fill-level measuring devices are, in particular, microwave fill-level measuring devices, ultrasonic fill-level measuring devices, time-domain reflectometry measuring devices, radiometric fill-level measuring devices, capacitive fill-level measuring devices, inductive fill-level measuring devices and/or temperature-sensitive fill-level measuring devices.

Pressure-measuring devices are, in particular, absolute, relative, or differential-pressure devices.

Temperature measuring devices are, in particular, measuring devices with thermocouples and/or temperature-dependent resistors.

Limit level-measuring devices are, in particular, vibronic limit level measuring devices, ultrasonic limit level measuring devices and/or capacitive limit level measuring devices.

Analytical measuring devices are, in particular, pH sensors, conductivity sensors, oxygen and active oxygen sensors, (spectro-)photometric sensors, and/or ion-selective electrodes.

In order to accommodate the connection circuit, field devices of the type described also comprise an electronics housing which, as proposed, e.g., in U.S. Pat. No. 6,397,683A or WO 00/36379 A1, can be arranged remotely from the sensing element and connected thereto only via a flexible cable or which, as shown, e.g., in EP 903 651 A1 or EP 1 008 836 A1, is arranged directly on the sensing element or in a sensing element housing which separately houses the sensing element. Often, the electronics housing is also used, as shown for example in EP 984 248 A1, U.S. Pat. Nos. 4,594,584 A1, 4,716,770 A1 or 6,352,000 B1, to accommodate some mechanical components of the sensing element, such as membrane-shaped, rod-shaped, sleeve-shaped or tubular deformation bodies or vibration bodies that deform under mechanical influence during operation; see also U.S. Pat. No. 6,352,000 B1 as mentioned at the outset. Field devices of the type described are also usually connected to one another and/or to corresponding process control computers via a data transmission system connected to the connection circuit, to which computers they send the measured value signals, for example via a (4 mA to 20 mA) current loop and/or via a digital data bus, and/or from which they receive operating data and/or control commands in a corresponding manner. The data transmission systems used here are, in particular, serial fieldbus systems such as PROFIBUS-PA, FOUNDATION FIELDBUS and the corresponding transmission protocols. By means of the process control computers, the transmitted measured value signals can be further processed and visualized as corresponding measurement results on monitors, for example, and/or converted into control signals for other field devices formed as actuators, such as magnetic valves, electric motors, etc.

Modern field devices are often so-called two-wire field devices, i.e., field devices in which the connection circuit is electrically connected to the external electrical energy supply only via a single pair of electrical cables (a two-wire conductor) and in which the connection circuit also transmits the current measured value via the single pair of electrical cables to an evaluation unit provided in the external electrical energy supply and/or electrically coupled thereto. The connection circuit comprises a current controller through which the supply current flows for setting and/or modulating, in particular clocking, the supply current, an internal operating and evaluation circuit for controlling the field device, and an internal supply circuit to which an internal input voltage of the field device electronics that is divided from the supply voltage is applied and which supplies the internal operating and evaluation circuit, having at least one voltage regulator through which a variable partial current of the supply current flows and which provides an internal useful voltage in the field device electronics that is substantially constantly regulated at a predefinable voltage level. Examples of such two-wire field devices, in particular two-wire measuring devices or two-wire actuators, can be found in WO 03/048874 A1, WO 02/45045 A1, WO 02/103327 A1, WO 00/48157 A1, WO 00/26739A1, U.S. Pat. Nos. 6,799,476 B1, 6,577,989 B2, 6,662,120 B1, 6,574,515 B1, 6,535,161 B1, 6,512,358 B1, 6,480,131 B1, 6,311,136 B1, 6,285,094 B1, 6,269,701 B1, 6,140,940 A1, 6,014,100 A1, 5,959,372 A1, 5,742,225 A1, 5,672,975 A1, 5,535,243 A1, 5,416,723 A1, 5,207,101 A1, 5,068,592 A1, 5,065,152 A1, 4,926,340 A1, 4,656,353 A1, 4,317,116 A1, EP 1 147 841 A1, EP 1 058 093 A1, EP 591 926 A1, EP 525 920 A1, EP 415 655 A1, DE 44 12 388 A1 or DE 39 34 007 A1.

Historically, such two-wire field devices are predominantly designed such that an instantaneous current intensity of the supply current currently flowing in the single pair of wires designed as a current loop, set to a value between 4 mA and 20 mA, simultaneously represents the measured value currently generated by the field device or the set value currently transmitted to the field device. As a result, a particular problem with such two-wire field devices is that the electrical power that can at least be nominally converted or is to be converted by the connection circuit—hereinafter referred to as “available power”—can fluctuate over a wide range during operation in a practically unpredictable manner. Taking this into account, modern two-wire field devices, in particular modern two-wire measuring devices with a (4 mA to 20 mA) current loop, are therefore usually designed such that their device functionality, which is implemented by means of a microcontroller provided in the evaluation and operating circuit, can be changed, and in this way the operating and evaluation circuit, which usually implements little power anyway, can be adapted to the currently available power.

ADVANCED PHYSICAL LAYER (APL) is a new communication standard for field devices. It is based on SINGLE PAIR ETHERNET (SPE) and should also allow an intrinsically safe supply (EX). Usually, multiple field devices are connected to a field switch and in order not to exceed the specified available power when these field devices are started simultaneously, as well as not to disrupt communication and/or operation when starting a single field device, the APL standard specifies rules for the start behavior. These include rules regarding inrush currents and current peaks, as well as the maximum current change and the maximum operating current. These values are limited, in particular when starting the field device.

In order to ensure a stable internal voltage and power supply, in particular in two-wire versions of APL field devices−i.e., the supply is via the APL cable—relatively high input capacitances are required as so-called buffers. However, without countermeasures, these cause a very high inrush current. If the input capacitances are so small that this effect is avoided, high current peaks will occur on the supply cable when various circuit components (e.g., buck-boost converter, MCU, etc.) start. However, rapid current changes (dI/dt) and excessively high current peaks (>55 mA) are not permitted when starting the field device.

The obvious solution is therefore to limit the input current until the field device is powered up and ready for operation. So-called current limiters are used for this purpose. A common, well-known circuit uses transistors which limit the current on a cable when a comparison value is exceeded. This has some disadvantages, however. For example, there is a loss of power due to a shunt resistor required to measure the current. At the moment of starting (i.e., until a minimum voltage is applied to the circuit components), the comparison circuit does not yet work completely and the permissible inrush current may be exceeded. In addition, rapid changes in the current may not be fully regulated due to the inertia of the circuit.

The object of the invention is to provide an alternative solution.

The object is achieved by a connection circuit for a field device according to claim 1 and a field device according to claim 15.

The connection circuit according to the invention for a field device comprises:

two connectors forming a two-wire interface, in particular one compliant with Ethernet-APL (IEEE Std 802.3cg-2019), for connecting a two-wire cable, via which the field device can be supplied with electrical power and a measurement signal can be transmitted from the field device;
a microcontroller for operating the field device;
a voltage converter which is connected upstream of the microcontroller,
wherein the voltage converter is configured to operate the microcontroller with an operating voltage;
   a supply capacitor which is connected upstream of the voltage converter,
wherein the supply capacitor is configured to absorb electrical energy when the connection circuit is started and to use it to supply the voltage converter;
   a first current limiting element which is connected upstream of the supply capacitor,
wherein the first current limiting element is designed to limit an input current below a permissible limit current when starting the connection circuit;
   a first bridging element which is connected in parallel with the first current limiting element and is intended to bridge the first current limiting element if a first criterion is satisfied; and
   a test element which is configured to check whether the first criterion is satisfied.

The supply capacitor allows a stable internal voltage and power supply by means of sufficiently large buffer capacitances. Furthermore, the charging current of the input capacitances of the field device is limited without a delay when starting. The capacitance of the supply capacitor is usually greater than 50 μF.

The first current limiting element is configured to limit the charging current of the supply capacitor so that the maximum inrush current specified by a standard, for example, is not exceeded. The test element is configured to ensure that the charging current flows via the first current limiting element if the voltage supply is insufficient (i.e., when the supply capacitor is charging). Furthermore, the test element is configured to bridge the first current limiting element via the first bridging element when the supply capacitor has reached a predetermined charge state.

Advantageous embodiments of the invention are the subject matter of the dependent claims.

One embodiment provides that the test element is configured to compare a first voltage applied between the connections and the first current limiting element with a second voltage applied between the first current limiting element and the supply capacitor,
wherein the first criterion is satisfied when the supply capacitor reaches a predetermined charge state and/or when the second voltage, in particular a sum of the second voltage and a preset voltage offset, is greater than the first voltage.

The voltage offset is selected such that this voltage (for bridging) is reliably reached, taking all tolerances into account, and the difference between the voltage leading to the bridging and the available charging voltage is as small as possible so that the compensating current does not generate an inadmissible current peak when bridging the current limiting element.

One embodiment provides that the connection circuit comprises:

a second current limiting element which is connected upstream of the supply capacitor,
wherein the second current limiting element is designed to limit a temporal current change resulting from recharging of the capacitor to below a current change limit, in particular no later than 1000 ms after the connection circuit is started.

The advantage of this embodiment is that it limits high current changes when all subsequent circuit components are started. This concerns, for example, voltage converters, microcontrollers, memories and integrated circuits for implementing communication (APL-Phy). The second current limiting element is therefore a dl/dt limiter.

One embodiment provides that, at a permitted maximum operating voltage of 15 V, the current change limit is less than 10 mA/ms,
wherein, at a permitted maximum operating voltage of 50 V, the current change limit is less than 100 mA/ms.

One embodiment provides that the second current limiting element is designed to allow, at a permitted maximum operating voltage of 15 V, fewer than 7 current peak events in which the temporal current change is greater than or equal to 10 mA/ms within 1000 ms after the connection circuit is started,
wherein the second current limiting element is designed to allow, at a permitted maximum operating voltage of 50 V, fewer than 7 current peak events in which the temporal current change is greater than or equal to 100 mA/ms within a sliding time interval of 1000 ms after the connection circuit is started.

One embodiment provides that the second current limiting element is designed such that, at a permitted maximum operating voltage of 15 V, a maximum current jump is less than or equal to 50 mA,
wherein the second current limiting element is designed such that, at a permitted maximum operating voltage of 50 V, a maximum current peak current at a current peak event is less than or equal to 50 mA.

One embodiment provides that the connection circuit comprises:

a second bridging element which is connected in parallel with the second current limiting element and is intended to bridge the second current limiting element if a second criterion is satisfied.

One embodiment provides that the microcontroller is in communication with the second bridging element and is configured to transmit a signal to the second bridging element if the second criterion is satisfied.

One embodiment provides that the second criterion is satisfied when the microcontroller has reached an operating state in which it is ready for communication.

One embodiment provides that the microcontroller is configured to transmit the signal with a such a delay that a current peak event generated during bridging by means of the first bridging element does not coincide in time with a current peak event generated by the starting voltage converter.

One embodiment provides that at a permitted maximum operating voltage of 15 V, the current limit corresponds to 95 mA, in particular 55.56 mA,
wherein, at a permitted maximum operating voltage of 50 V, the current limit corresponds to 1250 mA.

One embodiment provides that the first current limiting element has at least one electrical current limiting resistance R_{SBE1}, for which the following applies: 20 Ω≤R_{SBE1}≤1000 Ω.

The electrical current limiting resistance R_{SBE1} ensures the necessary charging current limitation. Since the current limiting resistance R_{SBE1} is always present in the charging path regardless of the available voltage, there is no reaction delay and the current is limited from the start.

One embodiment provides that the second current limiting element has an electrical current limiting resistance R_{SBE1}, for which the following applies: 3 Ω≤R_{SBE1}≤500 Ω.

One embodiment provides that the first bridging element is designed such that the first current limiting element is inactive after starting, in particular when a predetermined voltage across the first current limiting element is exceeded.

Once the first current limiting element has been bridged, the test element automatically receives a value that ensures that the bridging always remains switched on-regardless of the subsequent charge state of the input capacitances. This means that the current limitation is only active when the field device is started and the voltage of the input capacitance is defined to be lower than the external voltage. If the field device is only switched off briefly and the capacitors in the connection circuit are still charged, the start-up process is correspondingly shorter.

The field device according to the invention comprises:

a sensing element,
wherein the sensing element has a sensor for determining a process variable,
   an electronics housing,
wherein a connection circuit according to the invention is arranged in the electronics housing.

The invention is explained in greater detail with reference to the following figures, in which:

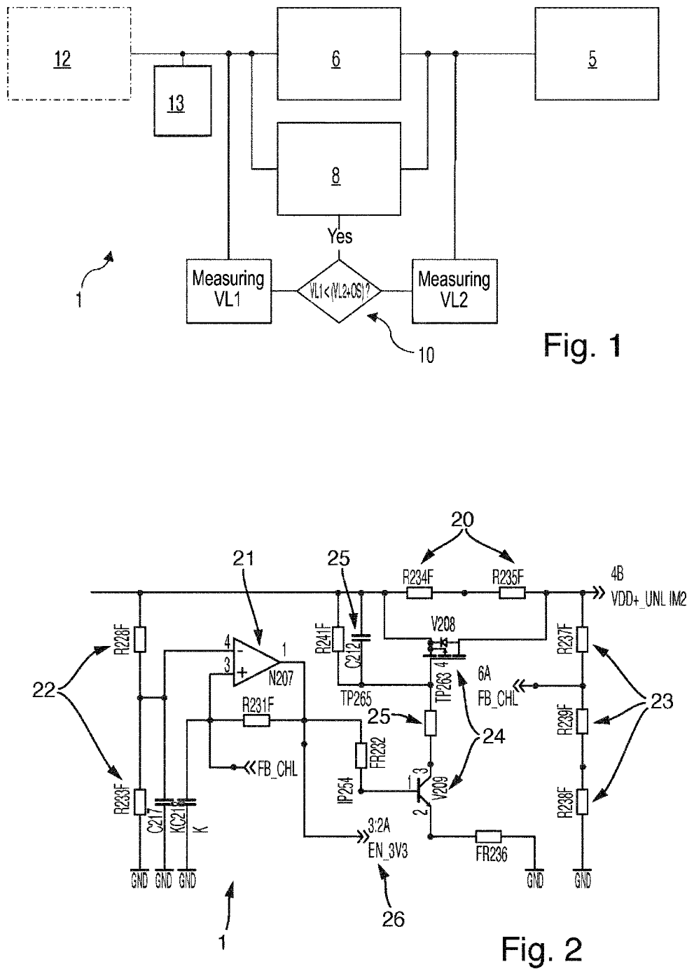

FIG. 1: shows a simplified representation of a first embodiment of the connection circuit;

FIG. 2: shows a section from a circuit diagram of the first embodiment of the connection circuit;

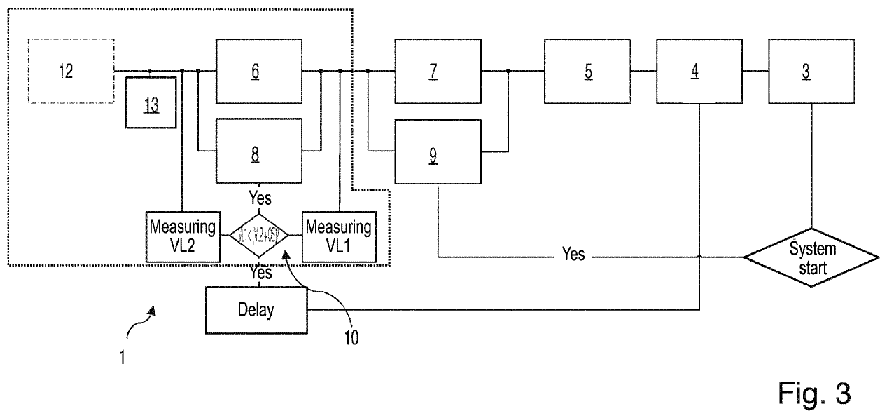

FIG. 3: shows a simplified representation of a second embodiment of the connection circuit;

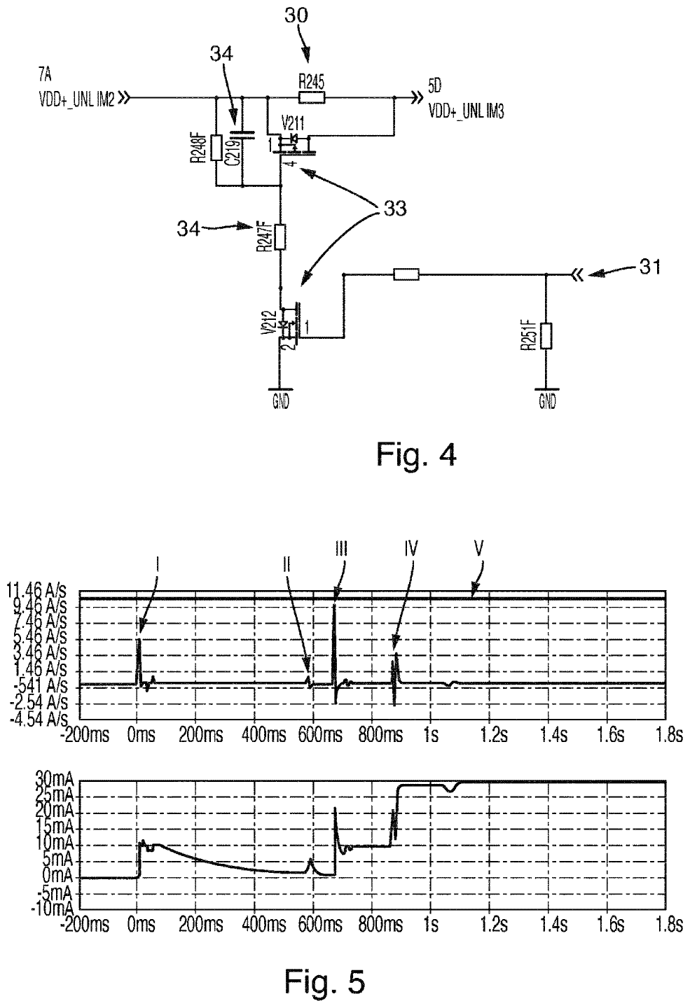

FIG. 4: shows a section from a circuit diagram of the second embodiment of the connection circuit;

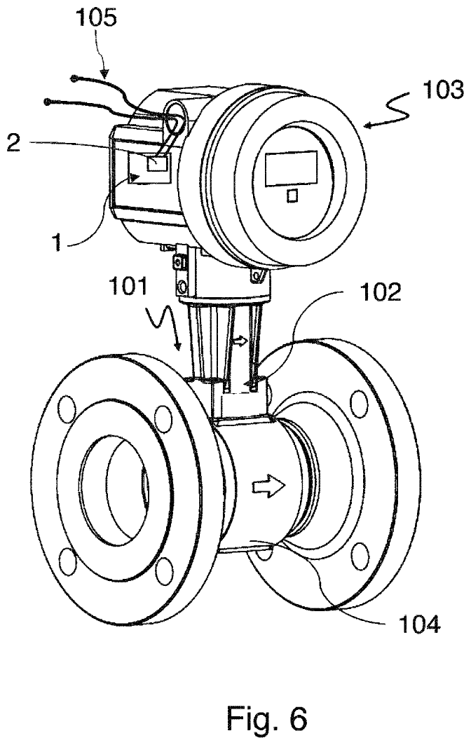

FIG. 5: shows a temporal course of the current and the temporal current change after start-up; and

FIG. 6: shows a field device according to the invention.

FIG. 1 shows a simplified representation of a first embodiment of the connection circuit 1 for a field device. This is only a section with a focus on the first current limiting element 6, so individual substantial components are not shown in FIG. 1, but are shown in the more complete representation in FIG. 3. The connection circuit 1 according to the invention comprises two connections (shown in FIG. 6) forming a two-wire interface, in particular one compliant with Ethernet-APL (IEEE Std 802.3cg-2019), for connecting a two-wire cable (also shown in FIG. 6), via which the field device can be supplied with electrical energy from a voltage source 12 and a measurement signal can be transmitted from the field device externally, for example to a control system.

Furthermore, the connection circuit 1 according to the invention comprises a microcontroller (shown in FIG. 3) for operating the field device. A microcontroller within the meaning of the application is a single-chip computer system or a semiconductor chip, which comprises a processor and optionally also the necessary RAM.

According to the invention, the connection circuit has a voltage converter (shown in FIG. 3) which is connected upstream of the microcontroller and is configured to convert the input voltage to the operating voltage with which the microcontroller can be operated. Commercially available voltage converters can be used as voltage converters.

FIG. 1 shows a supply capacitor 5 which is connected upstream of the voltage converter. This is configured to absorb electrical energy when the connection circuit 1 is started and to use it to supply the voltage converter. During start-up, the supply capacitor 5 is charged via the voltage source 12. A sufficiently high supply capacitance (e.g., 220 μF) is necessary for the internal supply of the connection circuit 1.

A first current limiting element 6 which is connected upstream of the supply capacitor 5 is designed such that it limits an input current below a permissible limit current when the connection circuit 1 is started. The first current limiting element 6 may comprise a field effect transistor, a relay, a bipolar transistor, an electrical current limiting resistor or another electronic component which is freely selectable from the prior art and fulfills the same function.

Since it is not desirable for the first current limiting element 6 to continue to limit the current during normal operation, a first bridging element 8 which is connected in parallel with the first current limiting element 6 is provided. This serves to bridge the first current limiting element 6 or is configured to bridge the first current limiting element 6 if a first criterion is satisfied. The first criterion can be a specification of the voltage present on an electronic component or a charge state of the supply capacitor.

Furthermore, a test element 10 which is configured to check whether the first criterion is satisfied is provided. The test element 10 may comprise a comparator or another suitable analog or digital circuit for comparing two voltages. The test element 10 is configured to compare a first voltage VL1 applied between the connections and the first current limiting element 6 with a second voltage VL2 applied between the first current limiting element 6 and the supply capacitor 5. The first criterion is satisfied, for example, when the supply capacitor 5 reaches a predetermined charge state and/or when the second voltage VL2, in particular a sum of the second voltage VL2 and a preset voltage offset OS, is greater than the first voltage VL1. If the first criterion is satisfied, the first bridging element 8 is activated and the first current limiting element 6 is deactivated. After the first criterion is satisfied, the current flows via the first bridging element 8.

The first bridging element 8 is designed such that the first current limiting element 6 is inactive after starting, in particular when a predetermined voltage across the first current limiting element 6 is exceeded. Thus, the first bridging element 8 can be designed as a switch or comprise at least one switching component which bridges (or short-circuits) the first current limiting element 6 and thus only becomes active when the predetermined voltage has built up at the first current limiting element 6. A conventional transistor, a field effect transistor, in particular a metal-oxide-semiconductor field effect transistor, a relay or analog switch is suitable as the first bridging element 8. It is also advantageous for a plurality of the switching components mentioned to work together.

The connection circuit 1 can have additional capacitors 13—which are not to be confused with the supply capacitor 5—with capacitances of less than 200 μJ or 500 μJ. These do not serve to supply the microcontroller, but are the cause of inrush current events.

FIG. 2 shows a section from a circuit diagram of the first embodiment of the connection circuit 1.

The first current limiting element consists of two electrical current limiting resistors 20 with the designations R234 and R235. Alternatively, the first current limiting element may consist of just one current limiting resistor or more than two current limiting resistors. If the first current limiting element is an electrical current limiting resistor, the following applies for the electrical resistance: 20 Ω≤R_{SBE1}≤1000 Ω. The required electrical resistance can be distributed over multiple individual electrical current limiting resistors, as shown.

The test element comprises a comparator 21, which is configured to compare the voltage applied to the measuring resistors 22 arranged between the input and the first current limiting element with the voltage applied to the measuring resistors 23 arranged between the first current limiting element and the voltage converter. The comparator 21 is designed to transmit a voltage signal to the voltage converter via the signal conductor 26 and to actuate the two switches 24 (V208 and V209) if the first criterion is satisfied, i.e., the inequality VL1<(VL2+OS).

Two damping components 25 are provided to minimize current changes that may occur when switching the two switches 24 (V208 and V209). The damping components 25 comprise an electrical resistor R242, which is arranged between the two switches 24, and a capacitor C212, which is connected in parallel with at least one of the switches 24. The electrical resistance of R242 and the capacitance of C212 are selected such that current changes occurring when the two switches 24 are switched do not exceed a specified tolerance value. The electrical resistance of R242 is preferably between 100 ohms and 1 megaohm. The capacitance of the capacitor C212 is preferably between 10 nF and 100 μF. A resistor R241 is arranged in parallel with the capacitor C212 and is configured to safely discharge the capacitor C219 when the power supply is switched off, so that the damping or delay is guaranteed at the next start-up.

In the illustrated embodiment, the measuring resistor 22 comprises two individual electrical resistors R233 and R228 connected in series and the measuring resistor 23 comprises three electrical resistors R238, R239 and R237 connected in series, wherein there is a node between the two electrical resistors R239 and R237, which is connected via an electrical conductor to a first input of the comparator 21. There is also a node between the resistors R233 and R228, which is connected via an electrical conductor to a second input of the comparator 21. Between the emitter of the transistor V209 and the ground potential, a resistor R236 is arranged which serves to reduce the discharge current in the capacitor C212 and is designed such that the switching of the transistor V209 takes place more slowly. The resistor R236 also ensures that the base current is limited by the transistor V209.

The two switches 24 (V208 and V209) comprise an (npn) bipolar transistor (V209), the base of which is connected to the output of the comparator 21 and the emitter to a ground potential and a p-MOSFET (V208), the gate of which is connected to the collector of the (npn) bipolar transistor via an electrical conductor.

FIG. 3 shows a simplified representation of a second embodiment of the connection circuit 1. The depicted representation comprises a part of FIG. 1 (see region with dotted border). In addition, the test element 10 is designed to transmit a signal, in particular a voltage signal, to the voltage converter if the first criterion is satisfied. This prevents the current peak events that occur when the voltage converter 4 is started from coinciding with the current peak events when bridging by means of the first bridging element.

In addition to the components already shown in FIG. 1, the connection circuit has a second current limiting element 7 which is connected upstream of the supply capacitor 5. This element is designed such that a temporal current change resulting from recharging of the capacitor 5 remains below a current change limit, in particular no later than 1000 ms after the connection circuit 1 is started. For a permitted maximum operating voltage of 15 V, the current change limit is less than 10 mA/ms and for a permitted maximum operating voltage of 50 V, the current change limit is less than 100 mA/ms.

Furthermore, it is fulfilled that the second current limiting element 7 is designed to allow, at a permitted maximum operating voltage of 15 V, fewer than 7 current peak events in which the temporal current change is greater than or equal to 10 mA/ms within 1000 ms after the connection circuit 1 is started. In the event that a maximum operating voltage of 50 V is permitted for the connection circuit 1, the second current limiting element 7 is designed such that it allows fewer than 7 current peak events in which the temporal current change is greater than or equal to 100 mA/ms within a sliding time interval of 1000 ms after the connection circuit is started. It is also advantageous if the second current limiting element 7 is designed such that, at a permitted maximum operating voltage of 15 V, a maximum current jump is less than or equal to 50 mA or, alternatively, the second current limiting element 7—for a permitted maximum operating voltage of 50 V—is designed such that a maximum value of the current peak in the event of a current peak event is less than or equal to 50 mA. The second current limiting element 7 may comprise a field effect transistor, a relay, a bipolar transistor, an electrical current limiting resistor or another electronic component which is freely selectable from the prior art and fulfills the same function.

Furthermore, a second bridging element 9 is provided which is connected in parallel with the second current limiting element 7 and is configured to bridge the second current limiting element 7 if a second criterion is satisfied. The second criterion can be a specification of the voltage present on an electronic component or a charge state of the supply capacitor or an operating state of the microcontroller/state in the program (software) of the microcontroller. The second criterion can be satisfied if the microcontroller 3 has reached an operating state in which it is ready for communication. Thus, the second bridging element 9 can be designed as a switch or comprise at least one switching component which bridges (or short-circuits) the second current limiting element 7 and thus only becomes active if the second criterion is satisfied.

The microcontroller 3 is in communication with the second bridging element 9 and is configured to transmit a signal, in particular a voltage signal, to the second bridging element 9 if the second criterion is satisfied. It is advantageous if the current peak events are coordinated appropriately so that they do not coincide in time. For this purpose, the microcontroller 3 is configured to transmit the signal, in particular the voltage signal, with such a delay that a current peak event generated during bridging by means of the second bridging element 8 does not coincide in time with a current peak event generated by the starting voltage converter 4.

The Ethernet-APL (IEEE Std 802.3cg-2019) standard specifies current limits. For example, at a permitted maximum operating voltage of 15 V, the current limit is 95 mA, in particular 55.56 mA, and at a permitted maximum operating voltage of 50 V, the current limit is 1250 mA.

FIG. 4 shows a section from a circuit diagram of the second embodiment of the connection circuit 1. The section shows only the part of the connection circuit 1 which is relevant for the description of the second current limiting element and the second bridging element. For the second current limiting element, its electrical current limiting resistance R_{SBE1} is within the limit of 3 and 500 ohms. In the illustrated embodiment, the second current limiting element comprises an electrical current limiting resistor 30. The second bridging element comprises two switches 33 of the same type (V211 and V212). Each of the switches V211 and V212 shown is a MOSFET. However, other switching components can also be used. The gate of the switch V212 is connected to the microcontroller via a signal conductor 31. The source is electrically connected to a ground potential and the drain is electrically connected to the gate of the other switch V211 by means of a conductor. A damping component 34—in this case an electrical resistor R247 (100 ohms to 1 megaohm)—is connected in series. The second switch 33 is configured such that when the switch is activated, the second current limiting element is bridged (or short-circuited). A capacitor C219 is connected in parallel with the switch V211 and also has the function of a damping component 34. The capacitance of the capacitor C219 is between 10 nF and 100 μF, limits included.

A resistor R248 is arranged in parallel with the capacitor C219 and is configured to safely discharge the capacitor C219 when the power supply is switched off, so that the damping or delay is guaranteed at the next start-up.

FIG. 5 shows a temporal course of the current and the temporal current change after start-up. The current was measured at the input of the connection circuit and the current change results from the time derivative of the current. When switched on at 0 ms, the current jumps in a step-like manner to approx. 10 mA. The inrush current surge causes a current change peak event I in the temporal current change. The maximum value of this event is approximately 5.46 A/s and is therefore below the specified 10 A/s. After the first inrush current surge, the current drops slightly. The first current surge comes from the charging current of the unlimited capacitances before the current limit. The charging current decreases as the voltage difference between the input and the large charging capacitor becomes equalized. At 600 ms, a current peak event is visible with a maximum current of approx. 5 mA. This is due to the bridging of a load resistor II. The current change is only minimal during this period. The next major spike in current and current change is measured at the time of the starting assistance III. After approx. 900 ms there is another step-like current jump. This is due to the bridging of the second current limiting element IV. The maximum deflection of the current change in this period is 3.46 A/s. The maximum values of all occurring coil current change peaks are therefore below the limit V of 10 A/s.

FIG. 6 shows a field device 100 according to the invention, which has a sensing element 101 with a sensor 102 for determining a process variable and an electronics housing 103. The connection circuit 1 according to the invention is arranged in the electronics housing 103. The connection circuit 1 has two connections 2 forming a two-wire interface, in particular one compliant with Ethemet-APL (IEEE Std 802.3cg-2019), for connecting a two-wire cable 105. The two-wire cable 105 is designed to supply the field device 100 with electrical energy and to transmit a measurement signal from the field device 100 to a monitoring unit. The field device 100 shown is a vortex flow meter. The sensing element 101 of a vortex flow meter usually comprises a measuring tube 104 with two connection devices (e.g., flanges) arranged on the front side and a bluff body arranged in the measuring tube 104 for forming a Kármán vortex street (hidden by the measuring tube 104). The sensor 102 comprises a sensor vane (also hidden by the measuring tube) which projects into the Kármán vortex street and a deformation body to which the sensor vane is attached and to which the movement of the sensor vane is transmitted. Examples of vortex flow meters are known, inter alia, from US 2006/0230841, US 2008/0072686, US 2011/0154913, US 2011/0247430, US 2016/0123783, US 2017/0284841, US 2019/0094054, U.S. Pat. Nos. 6,003,384, 6,101,885, 6,352,000, 6,910,387, or 6,938,496 and are also offered, inter alia, by the applicant, for example, under the trade names “PROWIRL D 200,” “PROWIRL F 200,” “PROWIRL O 200,” “PROWIRL R 200” (https://www.de.endress.com/de/messgeraete-fuer-die-prozesstechnik/durchflussmessung-produktuebersicht/vortex-wirbelz % C3%A4hler- durchflussmessung).

### LIST OF REFERENCE SIGNS

Connection circuit 1
Connections 2
Microcontroller 3
Voltage converter 4
Supply capacitor 5
First current limiting element 6
Second current limiting element 7
First bridging element 8
Second bridging element 9
Test element 10
Capacitance 11
Voltage source 12
Additional capacitors 13
Current limiting resistor 20
Comparator 21
Measuring resistor 22
Measuring resistor 23
Switch 24
Damping component 25
Signal conductor 26 to the voltage converter
Current limiting resistor 30
Signal conductor 31 from the microcontroller
Switch 33
Damping component 34
Field device 100
Sensing element 101
Sensor 102
Electronics housing 103
Inrush current surge I
Bridging the load resistor II
Starting assistance III
Bridging the first/second current limiting element IV
Limit V

1-15. (canceled)

16. A connection circuit for a field device, comprising:
two connections forming a two-wire interface for connecting a two-wire cable via which the field device can be supplied with electrical energy and via which a measurement signal can be transmitted from the field device;
a microcontroller for operating the field device;
a voltage converter which is connected upstream of the microcontroller, wherein the voltage converter is configured to operate the microcontroller with an operating voltage;
a supply capacitor which is connected upstream of the voltage converter, wherein the supply capacitor is configured to absorb electrical energy when the connection circuit is started and to use the absorbed electrical energy to supply the voltage converter;
a first current limiting element which is connected upstream of the supply capacitor, wherein the first current limiting element is designed to limit an input current below a permissible limit current when starting the connection circuit;
a first bridging element which is connected in parallel with the first current limiting element and is configured to bridge the first current limiting element if a first criterion is satisfied; and
a test element which is configured to check whether the first criterion is satisfied.

17. The connection circuit according to claim 16,
wherein the test element is configured to compare a first voltage applied between the two connections and the first current limiting element with a second voltage applied between the first current limiting element and the supply capacitor, and
wherein the first criterion is satisfied when the supply capacitor reaches a predetermined charge state and/or when the second voltage is greater than the first voltage.

18. The connection circuit according to claim 16, further comprising:
a second current limiting element which is connected upstream of the supply capacitor,
wherein the second current limiting element is designed to limit a temporal current change resulting from recharging of the capacitor to below a current change limit.

19. The connection circuit according to claim 18,
wherein, at a permitted maximum operating voltage of 15 V, the current change limit is less than 10 mA/ms, and
wherein, at a permitted maximum operating voltage of 50 V, the current change limit is less than 100 mA/ms.

20. The connection circuit according to claim 19,
wherein the second current limiting element is designed to allow, at a permitted maximum operating voltage of 15 V, fewer than 7 current peak events in which the temporal current change is greater than or equal to 10 mA/ms within 1000 ms after the connection circuit is started, and
wherein the second current limiting element is designed to allow, at a permitted maximum operating voltage of 50 V, fewer than 7 current peak events in which the temporal current change is greater than or equal to 100 mA/ms within a sliding time interval of 1000 ms after the connection circuit is started.

21. The connection circuit according to claim 20,
wherein the second current limiting element is designed such that, at a permitted maximum operating voltage of 15 V, a maximum current jump is less than or equal to 50 mA, and
wherein the second current limiting element is designed such that, at a permitted maximum operating voltage of 50 V, a maximum current peak current at a current peak event is less than or equal to 50 mA.

22. The connection circuit according to claim 18, further comprising:
a second bridging element which is connected in parallel with the second current limiting element and is configured to bridge the second current limiting element if a second criterion is satisfied.

23. The connection circuit according to claim 22,
wherein the microcontroller is in communication with the second bridging element and is configured to transmit a signal to the second bridging element if the second criterion is satisfied.

24. The connection circuit according to claim 23,
wherein the second criterion is satisfied when the microcontroller has reached an operating state in which it is ready for communication.

25. The connection circuit according to claim 16,
wherein the test element is configured to transmit a signal to the voltage converter with such a delay that a current peak event generated during bridging by means of the first bridging element does not coincide in time with a current peak event generated by the starting voltage converter.

26. The connection circuit according to claim 16,
wherein, at a permitted maximum operating voltage of 15 V, the current limit corresponds to 95 mA, and
wherein, at a permitted maximum operating voltage of 50 V, the current limit corresponds to 1250 mA.

27. The connection circuit according to claim 16,
wherein the first current limiting element has an electrical current limiting resistance in the range of 20 Ω to 1000 Ω, inclusive.

28. The connection circuit according to claim 27,
wherein the second current limiting element has an electrical current limiting resistance in the range of 3 Ω to 500 Ω, inclusive.

29. The connection circuit according to claim 16,
wherein the first bridging element is designed such that the first current limiting element is inactive after starting.

30. A field device, comprising:
a sensing element, wherein the sensing element has a sensor for determining a process variable;
an electronics housing; and
a connection circuit, including:
two connections forming a two-wire interface for connecting a two-wire cable via which the field device can be supplied with electrical energy and via which a measurement signal can be transmitted from the field device;
a microcontroller for operating the field device;
a voltage converter which is connected upstream of the microcontroller, wherein the voltage converter is configured to operate the microcontroller with an operating voltage;
a supply capacitor which is connected upstream of the voltage converter, wherein the supply capacitor is configured to absorb electrical energy when the connection circuit is started and to use the absorbed electrical energy to supply the voltage converter;
a first current limiting element which is connected upstream of the supply capacitor, wherein the first current limiting element is designed to limit an input current below a permissible limit current when starting the connection circuit;
a first bridging element which is connected in parallel with the first current limiting element and is configured to bridge the first current limiting element if a first criterion is satisfied; and
a test element which is configured to check whether the first criterion is satisfied, wherein the connection circuit is arranged in the electronics housing.
